(19) United States
(12) Patent Application Publication
(10) Pub. No.: US 2026/0052014 A1
(43) Pub. Date: Feb. 19, 2026

(54) OPTIMIZED HAMMING QUASI-CYCLIC POST-QUANTUM CRYPTOGRAPHIC METHOD

(71) Applicant: Commissariat à l’énergie atomique et aux énergies alternatives, Paris (FR)

(72) Inventor: Antoine LOISEAU, Grenoble Cedex 9 (FR)

(73) Assignee: Commissariat à l’énergie atomique et aux énergies alternatives, Paris (FR)

(21) Appl. No.: 19/250,260

(22) Filed: Jun. 26, 2025

(30) Foreign Application Priority Data
Jun. 28, 2024 (EP) 24306047

(51) Int. Cl. H04L 9/30

(52) U.S. Cl. CPC H04L 9/3026

(57) ABSTRACT

Optimized HQC post-quantum cryptographic method comprising: setting global parameters; generating a public key ( [symbol] ) and a private key ( [symbol] ); encrypting a message (m) with the public key to obtain a ciphertext (c); and decrypting the ciphertext with the private key to retrieve the message. The method computes a product between first and second operands of the size n binary polynomial type by way of a pointwise product between first and second transformed operand resulting in an AFFT like function applied to the first and second operand respectively, so that at least one element among the second private element (ÿ) of the private key ( [symbol] ), the first public element (\ddot{h}) of the public key ( [symbol] ) and the second public element (ÿ) of the public key ( [symbol] ) is a vector in the AFFT domain.

### BACKGROUND OF THE INVENTION

### Field of the Invention

The present invention concerns post-quantum cryptographic methods based on Error-Correcting Codes, in particular post-quantum cryptographic methods belonging to the Hamming Quasi-Cyclic—HQC scheme type.

### Description of Related Art

Asymmetric cryptographic methods are well-known. When two end devices, generally referred to as Alice and Bob, want to share a secret message (in particular an encryption key to be used for securing further exchanges), an asymmetric cryptographic method can be realized to transfer this message from Bob to Alice. Generally speaking, Alice generates a pair of keys, comprising a private key and a public key. Alice transmits her public key to Bob. Bob encrypts the message with Alice's public key and transmits the ciphertext to Alice. Alice retrieves the original message from the ciphertext using her private key. Thus, Bob and Alice now share the message.

However, it is thought that the basic asymmetric cryptographic methods, that are currently widely used, could be broken by a quantum algorithm running on a quantum computer.

It is the reason why new asymmetric cryptographic methods are looked after that could resist attacks by quantum algorithms. This asymmetric cryptographic methods are called post-quantum cryptographic methods.

Among the post-quantum cryptographic methods that have been identified to date, the Hamming Quasi-Cyclic-HQC scheme, that belongs to the specific group of post-quantum cryptographic methods based on Error-Correcting Code—ECC, should be standardized in the near future by the National Institute of Standards and Technology-NIST.

The HQC scheme is presented in details in the article C. Aguilar Melchor et al., «Hamming Quasi-Cyclic (HQC)», publishes on 23 Feb. 2024, which corresponds to the fourth round of standardization of the HQC scheme. This article can be downloaded at the URL: “https://csrc.nist.gov/Projects/post-quantum-cryptography/round-4-submissions”.

As explained in this article, the HQC scheme uses two types of codes: a decodable [n, k] code C, defined by a generator matrix

$$G ∈ {𝔽}_{2}^{k \times n} ,$$

and which can correct at least Δ errors, via an efficient algorithm C.Decode(·); and a random double-circulant [2n, n] code, of parity-check matrix (1, h).

Following the notations used in this article, an embodiment of the HQC scheme is illustrated in FIG. 1.

The HQC scheme 100 has four successive steps:
In the setup step 110, the global parameters of the algorithm are set based on the security level λ that is chosen. The variable param regroups the integers n,k,Δ,w,wᵣ and wₑ.
In the key generation step 120, performed by Alice, a pair of keys is computed, made up of a public encryption key pk and a private decryption key sk. In addition to some of the global parameters, this step of the HQC scheme uses additional parameters: h is randomly selected in the set [symbol] and the pair (x,y) is randomly selected in the set [symbol] _{w}× [symbol] _{w}, where [symbol] is the set of the binary words having a size of n bits, and [symbol] ⱼ is the sub-set of [symbol] gathering the binary words having exactly j bits equal to 1; the generator matrix G of the code C is publicly known. This is a matrix of k×n binary elements. In the HQC scheme the private decryption key sk is a pair of binary words of size n, x and y, while the public encryption key pk is a pair of binary words of size n, h and s, where s is the sum of x and h·y. The operator “·” will be discussed in detail below.
In the encryption step 130, performed by Bob, a ciphertext c is computed based on the message m to be exchanged with Alice (m is a binary word of k bits). The ciphertext c is of pair of binary words of size n, u and v. In addition to some of the global parameters, this step of the HQC scheme uses additional parameters: e is randomly selected in the set [symbol] _{w}_{ₑ}, and the pair (r₁,r₂) is randomly selected in the set [symbol] _{w}_{ᵣ}× [symbol] _{w}_{ᵣ}. u of the ciphertext c is then the sum of r₁ and h·r₂ and v is the sum of C.Encode(m), s·r₂ and e, where C.Encode(m) corresponds generally to the left product of the binary word m, seen as a vector, with matrix G (an can is often written as mG).
Finally, in the decryption step 140, performed by Alice on reception of the ciphertext c sent by Bob, the original message m is retrieved using the private decryption key sk known from Alice only. To this end the algorithm [symbol] .Decode(·) is applied on v minus u·y.

The HQC scheme presents very promising properties in terms of robustness against attacks, error correction, and so on.

However, the HQC scheme is relatively burdensome in terms of computation time or memory footprint.

In particular, the operator “·” corresponds to the product of two binary polynomials, whose size n depends on the level of security that is chosen.

Indeed, a word of n bits is mathematically equivalent to a binary polynomial of degree n−1, whose coefficient of degree i (i integer between 0 and n−1) is equal to the value of bit i+1 of the associated word.

In computer science, the product of polynomials is a major issue, in particular when the degree of the polynomials to handle is high, as this is the case in the HQC scheme.

Consequently, the h·y product in the key generation step, the h·r₂ and s·r₂ products in the encryption step, and the u·y product in the decryption step of the HQC scheme impose an heavy computational load.

This is a major bottleneck in particular when the HQC scheme is implemented in a lightweight computing device, such as a smart card or a microcontroller, whose microprocessor has limited capacities, or in a server, for example of a bank's computer system, having to deal with a huge number of cryptographic requests at the same time.

There is thus a need to optimize the HQC scheme to minimize its impact in terms of computation time or memory footprint and respect the constraints imposed by the intended platforms on which to deploy it.

The invention therefore aims at providing an optimized HQC scheme.

### BRIEF SUMMARY OF THE INVENTION

To this end, an aspect of the invention is an optimized HQC method implemented by first and second end points in order to share a message m, the method comprising successively: setting global parameters; generating, for the first end point, based on the global parameters, a pair of keys, the pair of keys comprising a public key [symbol] and a private key [symbol] , the public key being shared with the second end point; encrypting, by the second end-point, the message using the public key and transmitting the ciphertext c to the first end point; and, decrypting by the first end point the ciphertext using the private key to retrieve the message, the private key being made up of a first private element and a second private element and the public key being made up of a first public element and a second public element, the method involving at least one product between a first operand and a second operand, the first operand and the second operand each being a binary polynomial equivalent to a binary string of size n, characterized in that the method computes the at least one product by way of a pointwise product between a first transformed operand and a second transformed operand, the first transformed operand resulting in an Additive Fast Fourier Transform—AFFT like function applied to the first operand and the second transformed operand resulting in the AFFT like function applied to the second operand, the first transformed operand and the second transformed operand each being a vector in an AFFT domain, said vector in the AFFT domain being equivalent to a binary string of size 2n, and in that at least one element among the second private element (ÿ) of the private key [symbol] , the first public element \ddot{h} of the public key [symbol] and the second public element y of the public key [symbol] is a vector in the AFFT domain.

Another aspect of the invention is relative to a system comprising a first end point and a second end point, the system being adapted to realize the previous optimized HQC method.

Another aspect of the invention is relative to a smart card adapted to be used as the first end point of the previous system to realize the step of generating a pair of keys and the step of decrypting a ciphertext according to the previous optimized HQC.

Another aspect of the invention is relative to a server adapted to be used as the second end point of the previous system to realize the step of encrypting a message to output a ciphertext according the previous optimized HQC.

Another aspect of the invention is a non-transient information recording medium, comprising programming providing instructions to instantiate all or any of the steps of the previous optimized HQC, when those instructions are executed by the first end point or the second end point of a previous system.

### BRIEF DESCRIPTION OF THE DRAWINGS

The invention and its advantages will be better understood upon reading the following description of a preferred embodiment thereof, provided solely by way of example, this description being made with reference to the accompanying drawings, in which:

FIG. 1 shows an embodiment of the HQC scheme according to the prior art;

FIG. 2 shows an embodiment of the optimized HQC scheme according to the invention; and,

FIG. 3 is a computer system for implementing the optimized HQC scheme of FIG. 2.

### DETAILED DESCRIPTION OF THE INVENTION

The invention relies on a class of transformation functions, which is broadly referred to as the Additive Fast Fourier Transforms—AFFTs.

AFFT is a known class of techniques for multiplying binary polynomials.

There are several variants of AFFT in the literature.

Among them, the “classical” AFFT is presented in the article S. Gao et T. Mateer, «Additive Fast Fourier Transform over Finite Fields».

A particular AFFT, called the Frobenius Fast Fourier Transform—FFFT, is presented in J. v. d. Hoeven et R. Larrieu, «The Frobenius FFT,» 2017.

Another particular AFFT, called the Truncated Additive Frobenius Fast Fourier Transform—TAFFFT, is presented in W.-D. Li, M.-S. Chen et P.-C. Kuo, «Frobenius Additive Fast Fourier Transform,» 2018 or in M.-S. Chen, C.-M. Cheng, P.-C. Kuo, W.-D. Li et B.-Y. Yang, «Multiplying boolean Polynomials with Frobenius Partitions in Additive Fast Fourier Transform», 2018.

Generally speaking, an AFFT allows the binary polynomial product “a·b” to be performed by changing the representation of the operands a and b in order to move in a reciprocal space, where the product is easier to compute.

More specifically, we have the relation:

$$a . b = {AFFT}^{- 1} ( AFFT ( a ) ⊙ AFFT ( b ) ) \qquad ( 1 )$$

where: “·” Is the operator for the binary polynomial product; AFFT(a) is the Additive Fast Fourier Transform of binary polynomial a; AFFT(b) is the Additive Fast Fourier Transform of polynomial b; “⊙” is the operator for the pointwise multiplication; and AFFT⁻¹ is the Additive Fast Fourier inverse Transform, or inverse AFFT(a=AFFT⁻¹(AFFT(a))).

This relation means that it is equivalent to perform the binary polynomial product between a and b or to perform first an AFFT on both a and b to shift into the AFFT domain, to perform the pointwise multiplication between AFFT(a) and AFFT(b) in the AFFT domain, and to perform finally an inverse AFFT on the result of AFFT(a)⊙AFFT(b).

If operand a is a binary word of size n, its transform, ä=AFFT(a), is a vector belonging to the AFFT domain. The number of coordinates of this vector but also the dimension of each coordinate vary depending of a block parameter of the AFFT. However, each coordinate is a binary string, so that a vector in the AFFT domain is equivalent of a binary word, more precisely a binary word of size 2n.

The pointwise multiplication simply consists in multiplying the coordinates of AFFT(a) and AFFT(b), i.e. for each value of j (j integer between 1 and the number of coordinates of the vectors in the AFFT domain), in multiplying the coordinate j of vector AFFT(a) with the coordinate j of vector AFFT(b).

The result AFFT(a)⊙AFFT(b) is still a vector in the AFFT domain.

The inverse AFFT applied on the result of the pointwise product gives the value of the n bits word a·b.

However, in terms of computational load, for two operands of size n, while the computation of the binary polynomial product requires of the order of O(n²) operations, the computation via the AFFT domain according to equation (1) requires only O(n·log (n)) operations.

In terms of CPU cycle time for performing one product of two operands of size n, the following results are obtained (in arbitrary unit of time):

| Size | | |
|---|---|---|
| of each | Cycle time with AFFT | Cycle time without AFFT |
| operand | AFFT⁻¹(AFFT(a) ⊙ AFFT(b)) | a · b |
| n = 17669 | 9680 | 18000 |
| n = 35851 | 21130 | 86100 |
| n = 57637 | 21130 | 157400 |

However, the invention goes further by efficiently integrating AFFTs and inverse AFFTs into the HQC cryptographic protocols in order to gain on redundant transforms. In other words, the invention proposes to keep certain variables in the AFFT domain between steps of the HQC scheme and to transfer them between Alice and Bob, rather than their equivalent binary words. This will avoid having to perform an inverse transform on one variable at one end point, and the corresponding transform at the other end point. This will then reduce further the computational load of the algorithm.

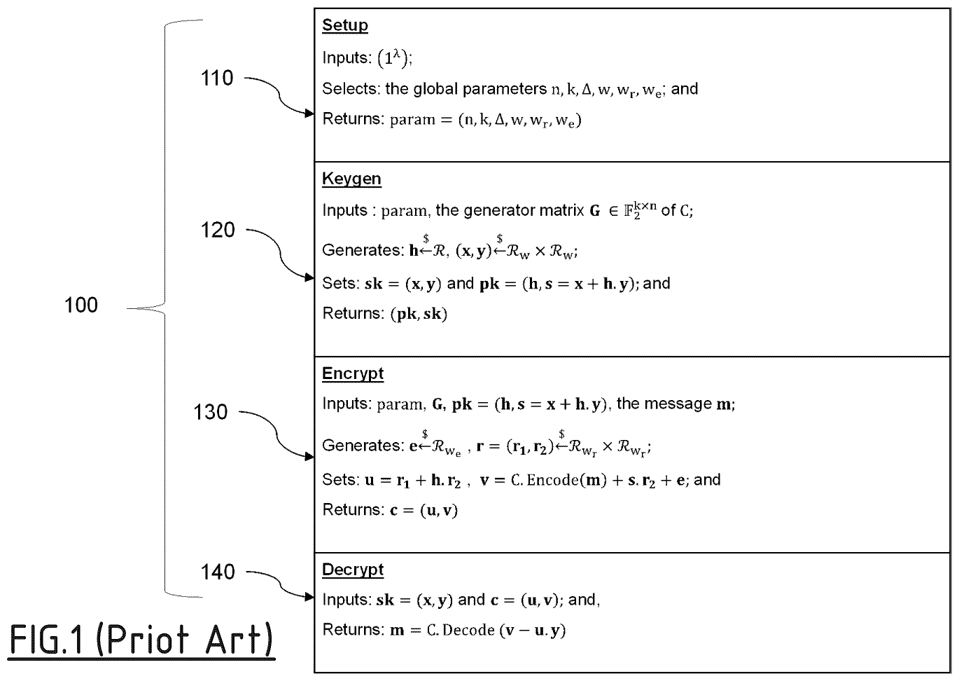

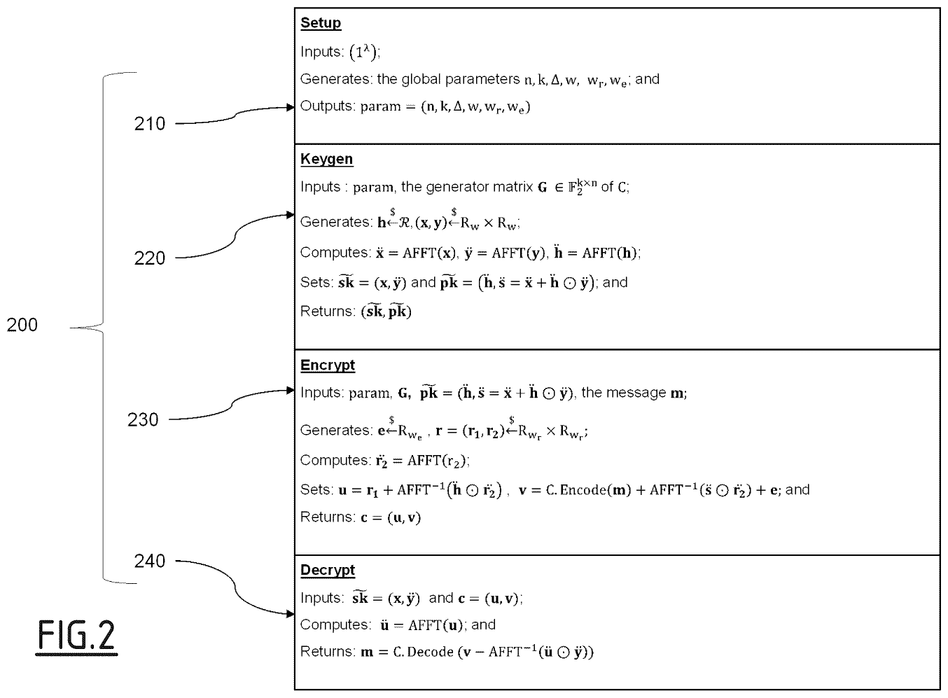

Following the notations used in FIG. 1, a preferred embodiment of the optimized HQC scheme according to the invention is presented in FIG. 2.

In the optimized HQC scheme 200, the setup step 210 is not altered compare to the setup step 110 of the HQC scheme 100 according to the state of the art.

The key generation step 220 is altered by computing the AFFTs of x, y and h, respectively. The transforms of these variables are denoted \ddot{x}, ÿ and \ddot{h}, respectively.

The private and public keys are now defined as [symbol] =(x,ÿ) and [symbol] =(\ddot{h},\ddot{s}=\ddot{x}+\ddot{h}⊙ÿ), respectively. The public key [symbol] is shared with Bob.

The encryption step 230 is also altered by computing the AFFT of r₂, referred to as [symbol] . In optimized HQC scheme 200, the ciphertext c is still the pair (u,v), but:
u is now the sum of r₁ and the inverse AFFT of the pointwise multiplication of h and [symbol] ; and,
v is now the sum of the C.Encode (·) operator on the secret message m to be transferred between Bob and Alice, the inverse AFFT of the pointwise multiplication of \ddot{s} and [symbol] , and e.

The ciphertext c is transmitted to Alice.

The decryption step 240 is altered by computing the AFFT of u. The message m is retrieved by applying the operator [symbol] .Decode(·) on v minus the inverse AFFT of the pointwise multiplication of ü and ÿ.

FIG. 1 shows that, between the key generation step 120 and the encryption step 130, the binary polynomial h is used in two different products. Thus, by using h rather than h in the public key [symbol] , an additional calculation of the AFFT of h is avoided in the encryption step 230.

Similarly, FIG. 1 shows that, between the key generation step 120 and the decryption step 140, the binary polynomial y appears in two products. Thus, by using ÿ rather than y in the public key [symbol] , an additional calculation of the AFFT of y is avoided in the encryption step 240.

The binary polynomial s appears successively in the key generation step (where its computation would implies an inverse AFFT) and the encryption step (where its use would necessitate an AFFT). Thus, by using s rather than s in the public key [symbol] , an inverse AFFT is avoided in the key generation step 220 and an AFFT is avoided in the encryption step 230.

According to the embodiment of FIG. 2, the key generation step 220 involves the computation of three AFFTs and one pointwise multiplication, but one inverse AFFT is spared in the computation of the public key [symbol] by staying in the AFFT domain. This corresponds to a reduction of 20% of the computational load for this key generation step when compare to the HQC scheme of FIG. 1.

The encryption step 230 involves the computation of one AFFT, two pointwise multiplications, and two inverse AFFTs, but two AFFTs are spared for \ddot{h} for and \ddot{s}. This corresponds to a reduction of 24% of the computational load for this encryption step when compare to the HQC scheme of FIG. 1.

The decryption step 240 involves one AFFT, one pointwise multiplications, and one inverse AFFT, but one AFFT is spared for y. This corresponds to a reduction of 18% of the computational load of this decryption step when compare to the HQC scheme of FIG. 1.

In the optimized HQC scheme, the format of the public and private keys are thus altered:

$$= ( x , \ddot{y} )$$

$$= ( \ddot{h} , \ddot{s} = \ddot{x} + \ddot{h} ⊙ \ddot{y} )$$

Since the length of the transformed operand is twice the one of the operand itself, [symbol] is 50% longer and [symbol] is 100% longer than in the classical version of the HQC scheme. Consequently, the size of the pair of keys used in the cryptographic method is a signature of the cryptographic method is the optimized HQC scheme according to the invention.

Alternative embodiments to the optimized HQC scheme of FIG. 2 are numerous. For example, to optimize the computation load of the decryption step, performed by Alice, the following operations may preferably be performed by Bob in the encryption step, to keep ü in the AFFT domain:

$${\ddot{r}}_{1} = AFFT ( {r}_{1} )$$

$$\ddot{u} = {\ddot{r}}_{1} + ( \ddot{h} ⊙ {\ddot{r}}_{2} )$$

The ciphertext transmitted by Bob is then:

$$\tilde{c} = ( \ddot{u} , v )$$

And the decryption step performed by Alice consists only in computing m:

$$m = C . Decode ( v - {AFFT}^{- 1} ( \ddot{u} ⊙ \ddot{y} ) )$$

In this alternative embodiment, the encryption step now involves two AFFTs and one inverse AFFT (in place of one AFFT and two inverse AFFTs), while the decryption step involves only one inverse AFFT (in place of one AFFT and one invers AFFT).

Globally, one inverse AFFT is thus spared. The ciphertext is however longer.

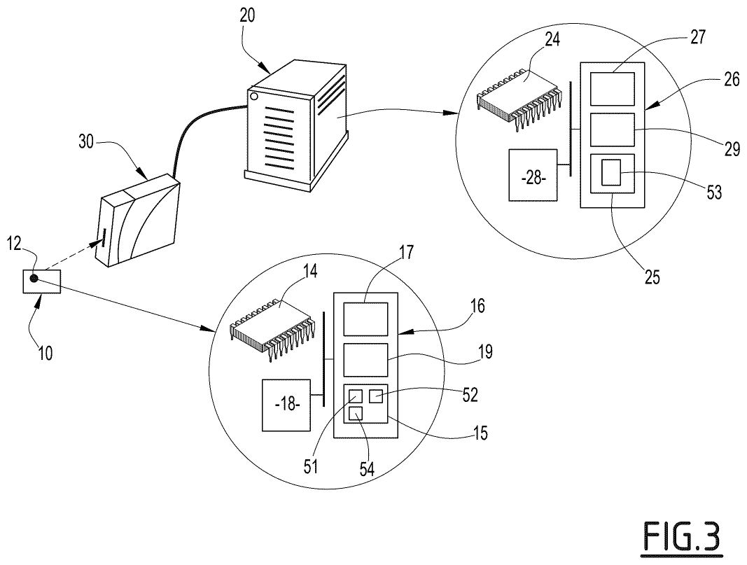

FIG. 3 is a possible application of the optimised HQC scheme of FIG. 2 in a system comprising a first end point and a second end point, in communication one with the other.

In the example of FIG. 3, the realization of the optimised HQC scheme by the system is based on the end points running pieces of software to perform the steps of the cryptographic method. Alternatively, the realization of the optimised HQC scheme by the system is based on each end points being pieces of hardware properly designed to perform the steps of the cryptographic method.

More specifically, in FIG. 3, the first endpoint, Alice, is the a smart card 10, and the second end point, Bob, is a server 20.

The smart card 10 comprises a chip 12, which includes a microprocessor 14, a memory 16 and an input/output interface 18.

The memory 16 comprises a memory space 17 dedicated to store variables and parameters of the cryptographic method.

The memory 16 also stores various computer programs whose instructions, when executed by the microprocessor 14, provides the smart card 10 with corresponding functionalities.

In particular, the memory 16 stores an application 18 in order to communicate with server 20.

In particular, the memory 16 stores a cryptographic program 15, that includes a decryption module 54, optionally a setup module 51, and optionally a key generation module 52, in order to implement the corresponding steps of the optimized HQC scheme 200.

Similarly, the server 20 is a computer comprising a processor 24, a memory 26 and an input/output interface 28. The interface 28 is in particular connected to a card reader 30, in which smart cards, like smart card 10, can be inserted to communicate with the server 20.

The memory 26 comprises a memory space 27 dedicated to store variables and parameters of the cryptographic method.

The memory 26 also stores computer programs, whose instructions, when executed by the processor 24, provides the server 20 with corresponding functionalities.

In particular, the memory 26 stores an application 29 in order to communicate with a smart card inserted in the reader 30.

In particular, the memory 26 stores a cryptographic program 25, that includes an encryption module 53, in order to implement the corresponding step of the optimized HQC scheme 200.

Off line, preferably when the smart card 10 is issued, the set up module 51 is executed to defines the global parameters of the optimized HQC scheme 200. The values of these global parameters are stored in memory space 17. Alternatively, the global parameter are otherwise set (for example by a standard entity) and stored in memory 17.

Similarly, off line, preferably when the smart card 10 is issued, the key generation module 52 is executed. It reads the values of the global parameters in the memory space 17 and computes the private and public keys, [symbol] and [symbol] . They are then stored into the memory space 17. Alternatively, the keys are otherwise generated (for example by an issuer entity) and stored in memory 17.

Then, on line, i.e. each time the smart card 10 is inserted into a reader, like the reader 30, after an initialisation procedure, the application 19 extracts the global parameters and the public key from the memory 16 and transmits them to the server 20 in a request for a secret message.

On receipt of the request, the application 29 stores the received variables and parameters in memory space 27.

The application 29 then select a message m pre-stored in the memory space

The application 29 launches the execution of the encryption module 53. This module reads the values of the global parameters, the public key and the message to be secretly exchanged in the memory space 27 and computes the cyphertext.

This latter is transmitted to the smart card 10, where it is stored in memory 16.

On reception of the ciphertext, the application 19 launches the decryption module 54. It reads the values of the global parameters, the private key and the ciphertext in the memory space 17 and retrieves the message m from the ciphertext.

The message m is store in memory 16.

The cryptographic method ends. The two end points are now sharing the message m. When this message is a cryptographic key, it can be used by each of the end point to cipher and decipher the data they exchange.

1. An optimized Hamming Quasi-Cyclic post-quantum cryptographic method, implemented by first and second end points in order to share a message, the method comprising successively:
setting global parameters;
generating, for the first end point, based on the global parameters, a pair of keys, the pair of keys comprising a public key and a private key, the public key being shared with the second end point;
encrypting, by the second end-point, the message using the public key to obtain a ciphertext and transmitting the ciphertext to the first end point; and,
decrypting by the first end point the ciphertext using the private key to retrieve the message;
the private key being made up of a first private element and a second private element and the public key being made up of a first public element and a second public element,
the method involving at least one product between a first operand and a second operand, the first operand and the second operand each being a binary polynomial equivalent to a binary string of size n,
wherein the method computes the at least one product by way of a pointwise product between a first transformed operand and a second transformed operand, the first transformed operand resulting in an Additive Fast Fourier Transform—AFFT like function applied to the first operand and the second transformed operand resulting in the AFFT like function applied to the second operand, the first transformed operand and the second transformed operand each being a vector in an AFFT domain, said vector in the AFFT domain being equivalent to a binary string of size 2n, and in that at least one element among the second private element of the private key, the first public element of the public key and the second public element of the public key is a vector in the AFFT domain.

2. The optimized Hamming Quasi-Cyclic post-quantum cryptographic method according to claim 1, wherein the AFFT like function is selected among a classical Additive Fast Fourier Transform, a Frobenius Fast Fourier Transform, a Truncated Additive Frobenius Fast Fourier Transform and the like.

3. The optimized Hamming Quasi-Cyclic post-quantum cryptographic method according to claim 1, wherein setting global parameters consists in, a security level being chosen, generating a set of global parameters comprising the integers n,k,Δ,w,wᵣ,wₑ, and wherein generating a pair of keys consists in generating h [symbol] , and (x,y) [symbol] _{w}× [symbol] _{w}, computing \ddot{x}=AFFT(x), ÿ=AFFT(y), and \ddot{h}=AFFT(h), and setting the private key [symbol] as (x,ÿ) and the public key [symbol] as (\ddot{h},\ddot{s}=\ddot{x}⊙ÿ), where AFFT(a) is the transformed operand resulting in an Additive Fast Fourier Transform-AFFT like function applied to the operand a, ⊙ is the operator of the pointwise product, and [symbol] is the set of the binary words having a size of n bits, and [symbol] ⱼ is the sub-set of [symbol] gathering the binary words having exactly j bits equal to 1.

4. The optimized Hamming Quasi-Cyclic post-quantum cryptographic method according to claim 3, wherein: encrypting the message m consists in, an encoding function C.Encode(·) being given, generating e [symbol] _{w}_{ₑ}, and r=(r₁,r₂) [symbol] _{w}_{ᵣ}× [symbol] _{w}_{ᵣ}, computing [symbol] =AFT(r₂), and setting u=r₁+AFT⁻¹(\ddot{h}⊙ [symbol] ), and v=C.Encode(m)+AFFT⁻¹(\ddot{s}⊙ [symbol] )+e, the ciphertext c being defined as (u,v); and decrypting the message m consists in, a decoding function C.Decode(·) being given, generating ü=AFFT(u) and returning m as C.Decode(v−AFFT⁻¹(ü⊙ÿ)).

5. The optimized Hamming Quasi-Cyclic post-quantum cryptographic method according to claim 3, wherein: encrypting the message m consists in, and encoding function C.Encode (·) being given, generating e [symbol] _{w}_{ₑ}, and r=(r₁,r₂) [symbol] _{w}_{ᵣ}× [symbol] _{w}_{ᵣ}, computing [symbol] =AFT(r₂), and [symbol] =AFFT(r₁), setting ü= [symbol] +(\ddot{h}⊙ [symbol] ) and v=C.Encode(m)+AFFT⁻¹(\ddot{s}⊙ [symbol] )+e, the ciphertext \tilde{c} being defined as (ü,v); and decrypting the message m consists in, a decoding function C.Decode(·) being given, returning m as C.Decode(v−AFFT⁻¹(ü⊙ÿ)).

6. The system comprising a first end point and a second end point, the system being adapted to realize an optimized Hamming Quasi-Cyclic post-quantum cryptographic method according to claim 1.

7. The smart card adapted to be used as the first end point in the system according to claim 6 to realize the step of generating a pair of keys and the step of decrypting a ciphertext according to the optimized Hamming Quasi-Cyclic post-quantum cryptographic method.

8. The server adapted to be used as the second end point in the system according to claim 6 to realize the step of encrypting a message to output a ciphertext according the optimized Hamming Quasi-Cyclic post-quantum cryptographic method.

9. A non-transient information recording medium, comprising programming providing instructions to instantiate all or any of the steps of an optimized Hamming Quasi-Cyclic post-quantum cryptographic method according claim 1, when those instructions are executed by a computing system.
